(19) United States
(12) Patent Application Publication
(10) Pub. No.: US 2002/0116369 A1
(43) Pub. Date: Aug. 22, 2002

(54) Method of displaying unknown words of a digital article

(76) Inventor: Ho-Hsin Liao, Taipei (TW)

Correspondence Address: BACON & THOMAS, PLLC, 625 SLATERS LANE, FOURTH FLOOR, ALEXANDRIA, VA, 22314

(21) Appl. No.: 10/073,251

(22) Filed: Feb. 13, 2002

(30) Foreign Application Priority Data
Feb. 19, 2001 (TW) 90103737

(51) Int. Cl. G06F 7/00

(52) U.S. Cl. 707/2

(57) ABSTRACT

The invention relates to a method of displaying unknown-word(s) such that an electronic apparatus, such as a computer or PDA displays unknown-word(s) of a digital article. The present invention uses a vocabulary database to find unknown word(s) of said digital article and marks found unknown word(s) and/or displays found unknown word(s) together as an unknown-vocabulary area so that a reader knows where unknown word(s) are in said digital article. In addition, the present invention provides a method to allow a user to change a known word to an unknown word in said digital article and vice versa, so that the vocabulary database is updated and becomes more accurate

### BACKGROUND OF THE INVENTION

1. Field of the Invention

The invention relates to a method of displaying unknown words through a display device, such as a screen on an electronic apparatus (e.g. PDA, PC, Laptop, etc.) that can execute the software program using the method of the invention.

2. Description of Related Art

It is becoming more popular to use a computer, a PDA (Personal Digital Assistant), or Laptop and the like to read material (e.g. web page, text, electronic book) for learning or educational purposes.

The material usually includes unknown words. Therefore, many dictionary software programs have been developed to assist users.

Some of the dictionary software programs are called “on-line” dictionaries. Users can move the cursor to an unknown word and press the right button of the mouse. Then a pop-up window will be displayed to define the unknown word. Therefore, defining unknown words is user friendly.

However, regardless if a user uses a traditional paper-dictionary or a dictionary software program, some problems cannot be solved. For example: a user is not aware of unknown words before reading the material. Awareness of unknown words is beneficial because the user wants to define unknown words in advance to later read the material (e.g. an article, an electronic book) smoothly; or the user can decide whether to read material dependent upon the difficulty or types of unknown words; or the user can choose appropriate learning material by knowing unknown words in advance. On the other hand, a user may also want to know how many unknown words still need to be learned in a previously read article. Listing the unknown words allows the user to achieve the above stated tasks easily.

There are other educational purposes to listing words for an article. Such as traditional language teaching articles listing new words. However, the new words listed by traditional language teaching articles are the same for all users. In fact, because of the different background of users, such lists of new words are non-personalized and are usually inaccurate for each different user.

Therefore, there is a necessity to solve the above-existing problems.

### SUMMARY OF THE INVENTION

An object of the present invention is to display unknown words of digital articles, by marking unknown words or displaying found unknown words together as an unknown-vocabulary area.

Another object of the present invention is to allow a user to change a known word to an unknown word in the digital article and vice versa. Therefore, the users accuracy of finding unknown words from digital articles will increase.

To achieve the aforesaid and other objects of the invention, the preferred embodiment according to the present invention uses a vocabulary database to find unknown words in the digital article and marks found unknown words or displays found unknown words together as an unknown word area so that the user knows where the unknown words are in the digital article. The vocabulary database is personalized and can be a known-vocabulary database, an unknown-vocabulary database, or a combined vocabulary database with a known-vocabulary database and an unknown-vocabulary database.

In addition, the preferred embodiment provides a method allowing a user to change known-vocabulary to unknown-vocabulary in the digital article and vice versa, so that the vocabulary database is constantly updated becoming more accurate for the user. Therefore, the vocabulary database becomes personalized for the user.

The present invention not only improves the drawbacks of the current art but also creates new advantages. For example: a reader can choose a digital article according to the ratio of known words to unknown words to attain a digital article at the appropriate reading level.

### BRIEF DESCRIPTION OF THE DRAWINGS

FIG. 1 shows a hardware structure;

FIG. 2 shows a known-vocabulary database;

FIG. 3 shows an unknown-vocabulary database;

FIG. 4 shows a combined vocabulary database

FIG. 4a shows another combined vocabulary database

FIG. 5 presents a flowchart of steps embodying a general main procedure according to the present invention;

FIG. 6 presents another flowchart of steps embodying a general main procedure according to the present invention;

FIG. 7 presents a flowchart of steps embodying a general amending procedure

FIG. 8 presents another flowchart of steps embodying a general amending procedure FIG. 9 shows the displaying screen of a digital article processed by the present invention;

FIG. 10 shows the display screen of a digital article during the amending procedure according to the present invention;

FIG. 11 shows the display screen of a digital article after the amending procedure according to the present invention; and

FIG. 12 shows an explanation diagram for handling databases according to the present invention.

### DETAIL DESCRIPTION OF THE PREFERRED EMBODIMENT

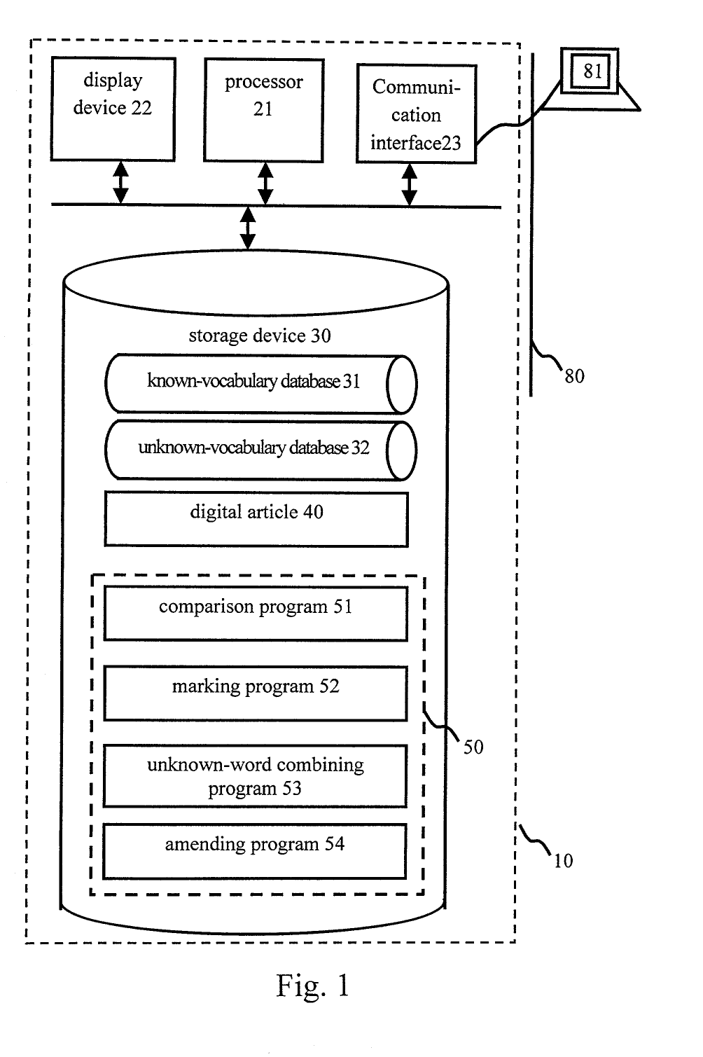

Refer to FIG. 1, the hardware structure embodiment of the present invention. The present invention, an electronic apparatus able to display digital articles 10, can be a general computer, a PDA (Personal Digital Assistant), an electronic book reader, a pocket PC, a laptop, mobile phone, etc. The present invention can be any electronic apparatus 10 that comprises a processor 21 to execute a software program 50; a display device 22 (e.g. screen, electronic paper) to display material; and a storage device 30 (e.g. hard drives, floppy disks, RAM, EPROM, Memory Card, CD-ROM). The electronic apparatus 10 may also comprise a communication interface 23 to connect with a network. For example: connecting with the well known “Internet 80” to access website 81. The storage device 30 stores a known-vocabulary database 31, an unknown-vocabulary database 32, one or multiple digital articles 40 and at least a software program 50. The major portion of software program 50 mainly comprises a comparison program 51, a marking program 52, an unknown-word combining program 53, and an amending program 54. With regard to the material and programs saved in storage device 30 they will be described in more detail here below.

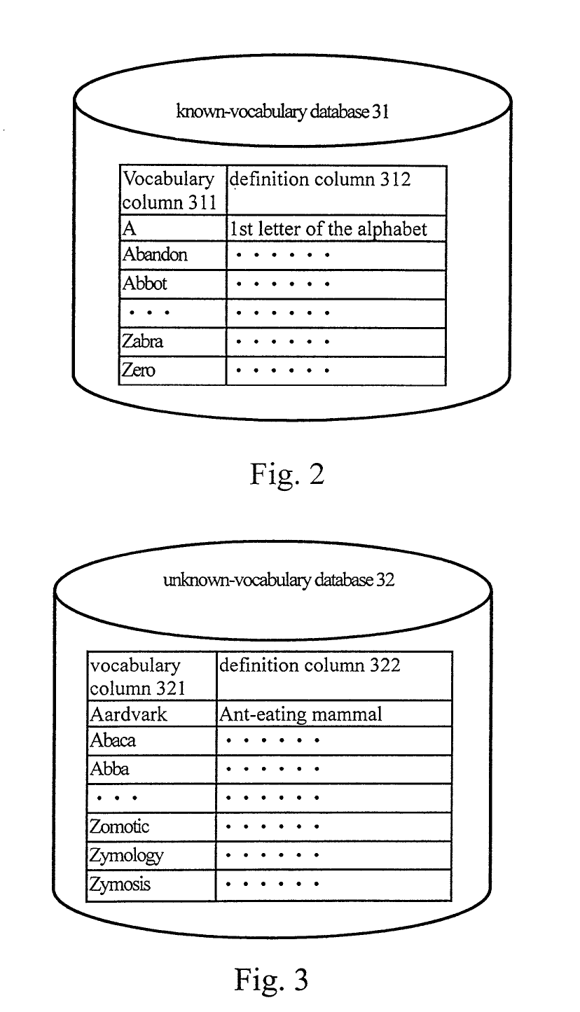

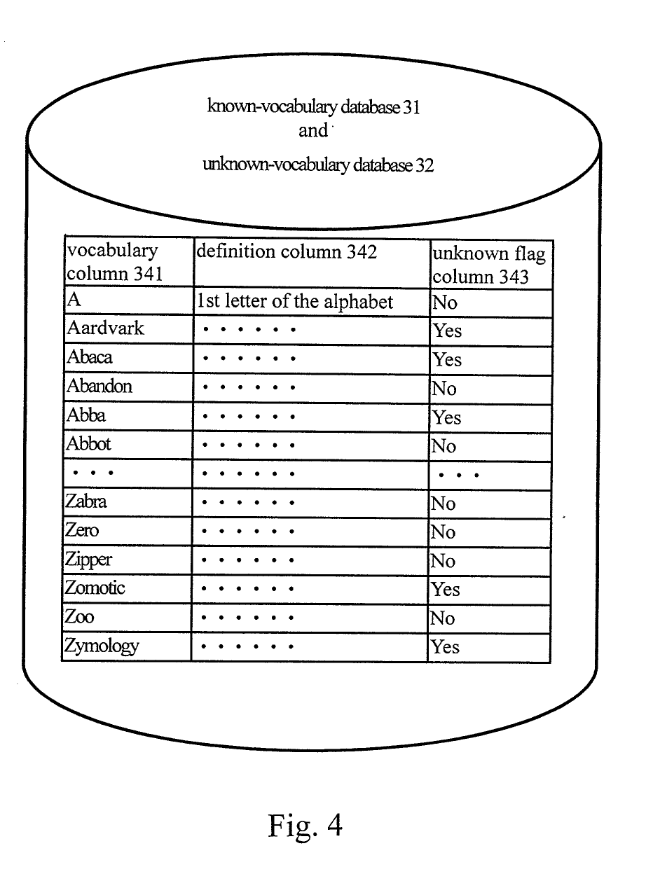

Refer to FIG. 2, the embodiment of a known-vocabulary database 31. The known-vocabulary database 31 records the user's known words. In this embodiment, the known-vocabulary database 31 includes a vocabulary column 311 to record known words, and a definition column 312 to define each known word. Refer to FIG. 3, the embodiment of an unknown-vocabulary database 32. The unknown-vocabulary database 32 includes a vocabulary column 321 to record unknown words, and a definition column 322 to define each unknown word.

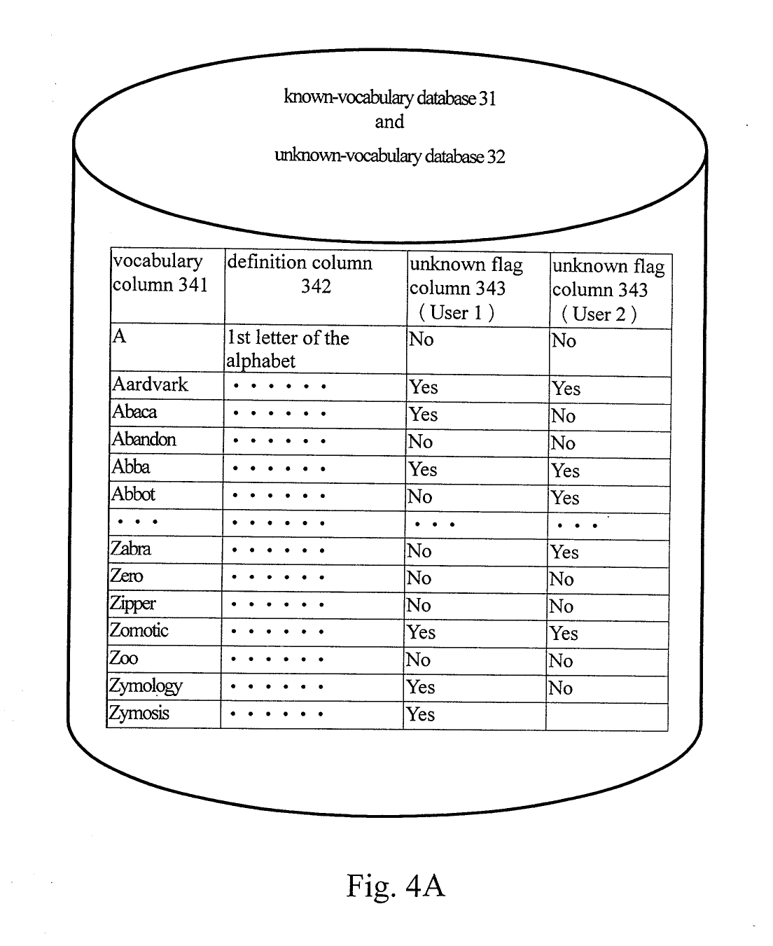

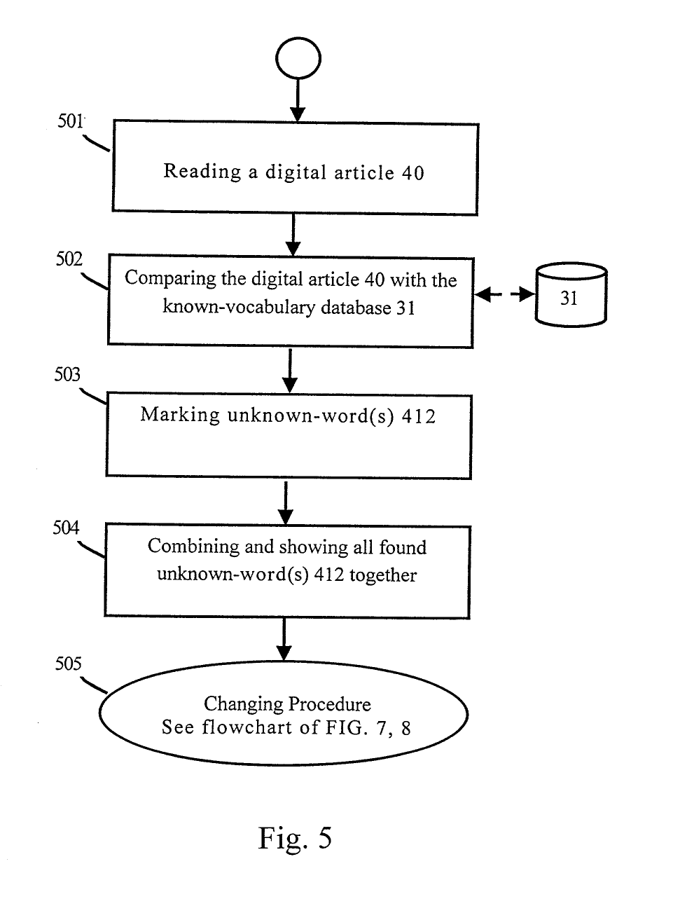

In fact, the known-vocabulary database 31 and the unknown-vocabulary database 32 can be combined as one database. The embodiment, shown in the FIG. 4, also includes a vocabulary column 341 and a definition column 342, but further includes the unknown flag column 343. Therefore, all the words with “YES” in the unknown flag column 343 comprise the unknown-vocabulary database 32. Refer to FIG. 4a for another embodiment. This embodiment has multiple unknown flag columns 343 to enable more than one user at a time with the same electronic apparatus 10 of the present inventions. Note that the unknown flag column 343 can also be defined as a known flag column 343 to achieve the same purpose.

The main purpose of FIG. 4 is to explain that the known-vocabulary database 31 and the unknown-vocabulary database 32 can be managed in different ways. For example: as one database or two databases.

In addition, the definition columns 312, 322, or 342 are not really necessary, since the purpose of current dictionary software is to define words. As such the known-vocabulary database 31 and the unknown-vocabulary database 32 need only list known or unknown words. However, with the definition columns 312, 322, or 342, the known-vocabulary database 31 and the unknown-vocabulary database 32 can be applied as dictionary software. Please notice that the language used in the definition columns 312, 322, or 342 can be different from that of the vocabulary columns 311, 321, or 341. For example: the language in vocabulary columns 311, 321, or 341 is English, and the language in definition columns 312, 322, or 342 is Chinese. Also notice that numerous columns can be added to databases 31 or 32, such as a phonetic recording column, or an example sentence column.

The known-vocabulary database 31 and the unknown-vocabulary database 32 can have different default levels corresponding to different levels of readers or users. The database 31 or 32 can also be generated through testing the user's knowledge level, etc. Since the set up or structures of databases 31 or 32 are not the main issue of the present invention, these details are not discussed here.

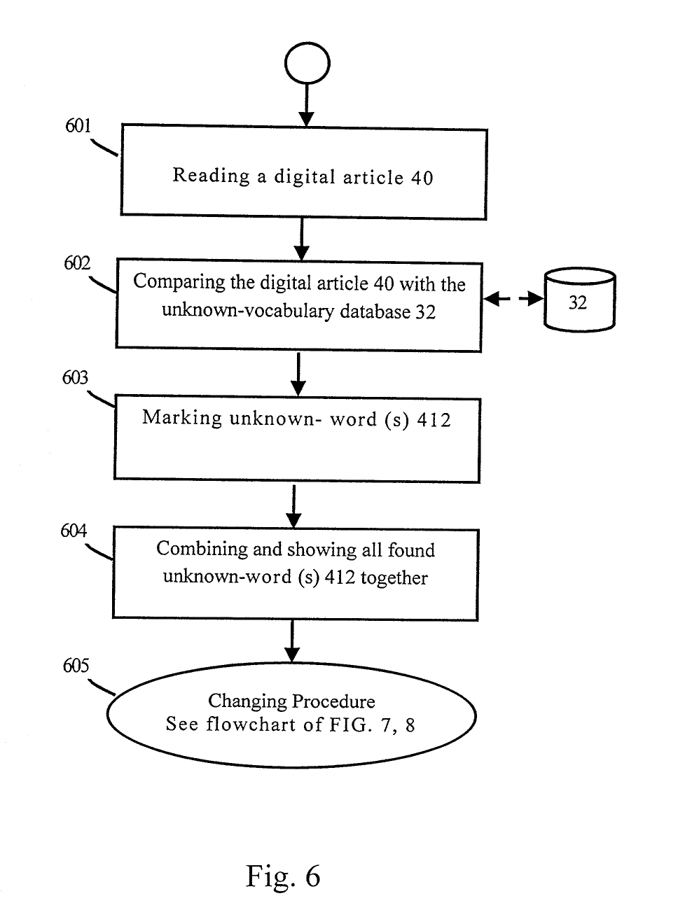

Refer to FIG. 5, the first embodiment of the main flowchart of the present invention, and to FIG. 9, a digital article 40 processed by the present invention, together as follows:

Step 501:

Reading a digital article 40 through the software program 50. The embodiment of the digital article 40 is shown in FIG. 9 (excluding unknown-vocabulary area 45, and underlines). The format of the digital article 40 can be “html”, “doc”, or any other text format. The digital article 40 can be saved in the storage device 30 or can be downloaded files from website 81 etc.

Step 502:

Comparing the digital article 40 with the known-vocabulary database 31. The comparison program 51 executes this step for comparing which word 41 of the digital article 40 is listed (or not listed) in the vocabulary column 311 of the known-vocabulary database 31. The basic algorithm of the comparison program 51 can be similar to or the same as the well-known “spell check” program.

Step 503:

Marking unknown words 412 of the digital article 40 which are not in the known-vocabulary database 31. The marking program 52 executes this step. In this embodiment, the marking program 52 adds an underline under the unknown word 412. Different marking schemes can be applied, such as different color, bold type, reverse display, or adding phonation or special symbols behind unknown word(s) 412. The main purpose of this step is to allow users to differentiate known words 411 (e.g. became, concept, brain in FIG. 9) from unknown words 412 (e.g. neurons, fundamental, cognitive in FIG. 9). The basic algorithm of the marking program 52 can be similar to or the same as the well-known “incorrect spelling marker” program of MS-Word98 which marks “ [symbol] ” under incorrectly spelled words.

Step 504:

Combining and showing all found unknown words 412 together as an unknown-vocabulary area 45. For example, the unknown-vocabulary area 45 can be arranged at the top of the digital article 40 as shown in FIG. 9. The advantage of the unknown-vocabulary area 45 allows the user to know the possible unknown word(s) for the digital article 40 in advance. Also, the user knows the number or difficulty of the unknown words. The unknown-vocabulary area 45 may not only show unknown words 412, but may also show the meaning of these unknown words 412. This step is executed by program 53 which is easily coded by those skilled in the art.

Step 505:

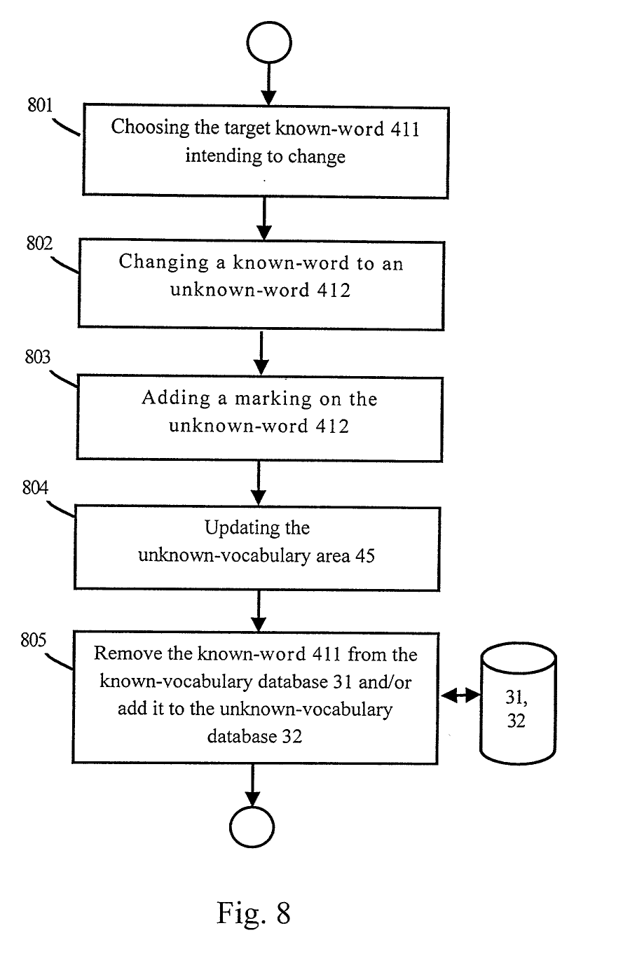

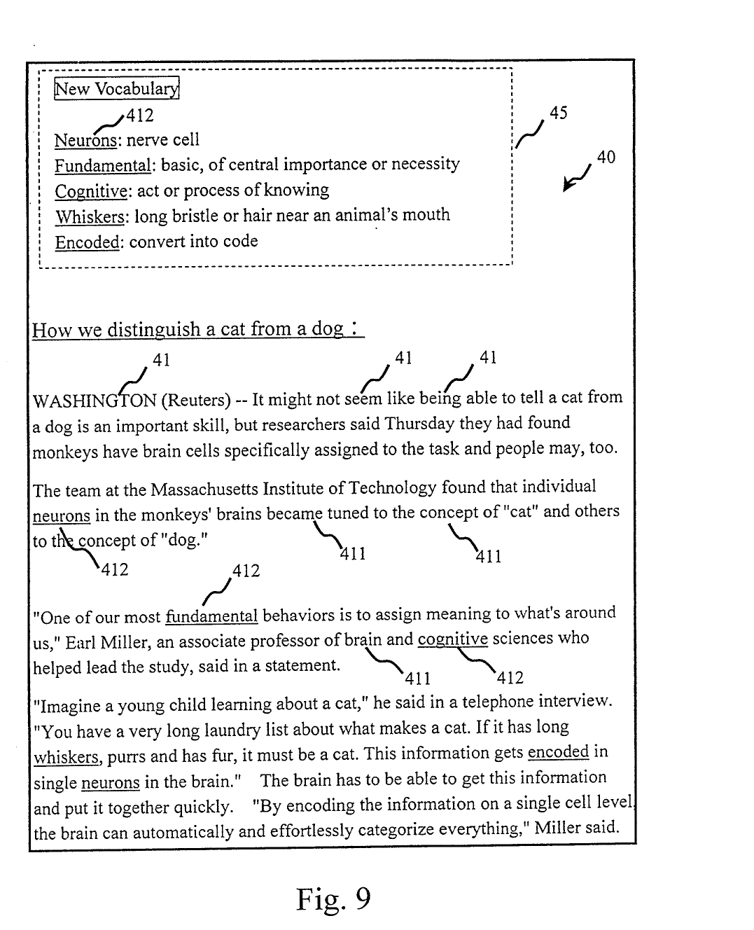

Refer to the FIG. 7 for changing an unknown word 412 to a known word 411. For changing a known word 411 to an unknown word 412, please refer to the flowchart shown in FIG. 8.

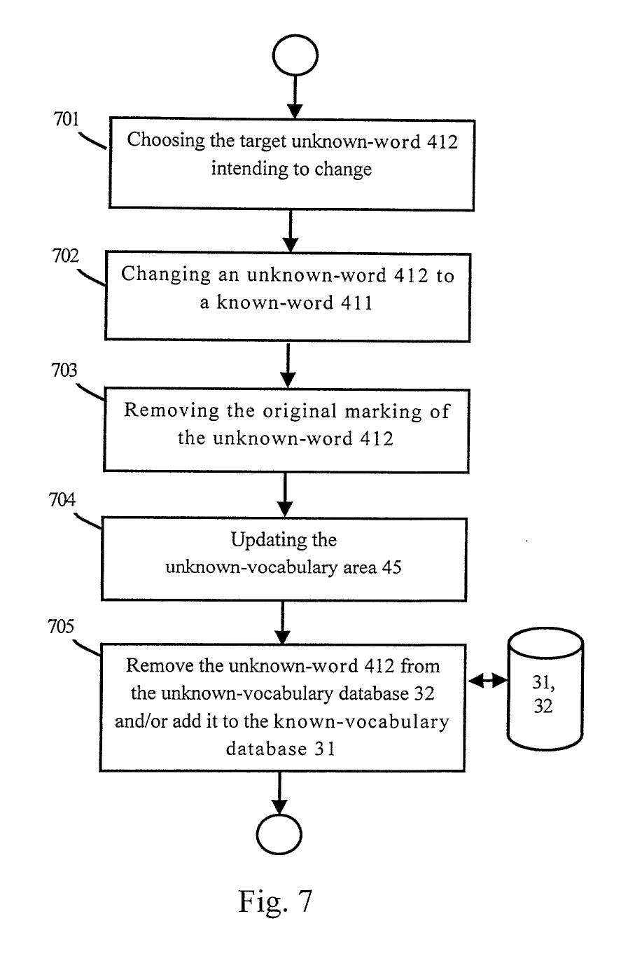

Refer to FIG. 6, the second embodiment of the main flowchart of the present invention. The main differences from the first embodiment are steps 602 and 603. The first embodiment uses the known-vocabulary database 31 for finding unknown-word(s) 412, but the second embodiment uses the unknown-vocabulary database 32 for finding unknown word(s) 412.

Step 601: Please refer to step 501.

Step 602:

Comparing the digital article 40 with the unknown-vocabulary database 32. The comparison program 51 executes this step comparing which word 41 of the digital article 40 is listed (or not listed) in the vocabulary column 321 of the unknown-vocabulary database 32.

Step 603:

Marking unknown-word(s) 412 of the digital article 40 which are in the unknown-vocabulary database 32.

Step 604: Please refer to step 504.

Step 605: Please refer to step 505.

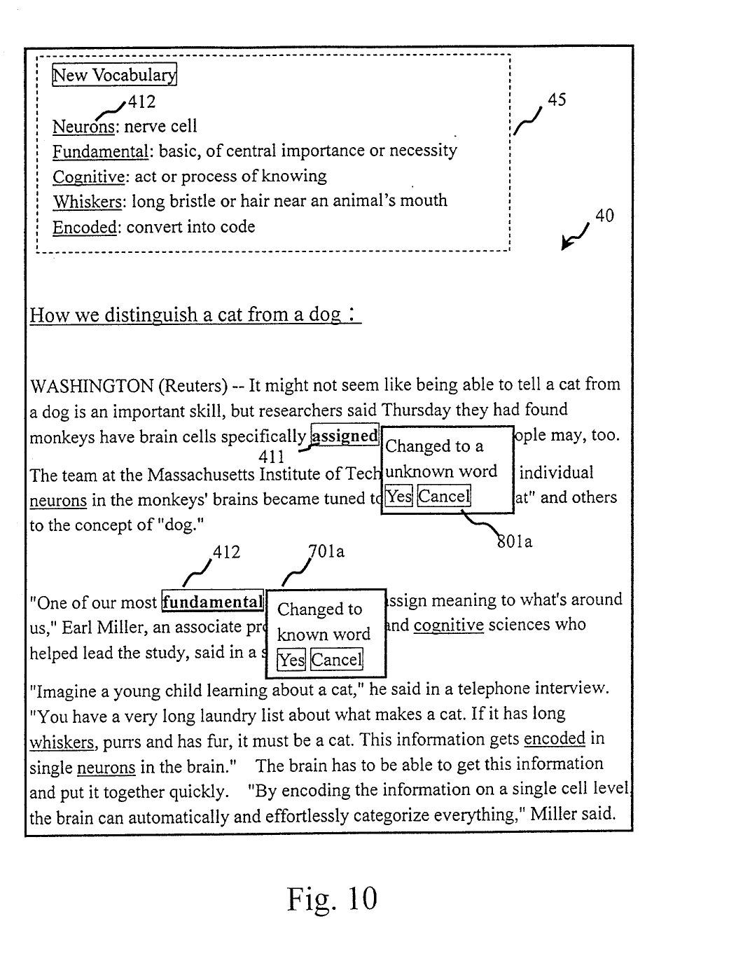

Please refer to FIG. 7 for the flowchart on changing an unknown-word 412 to a known-word 411. Amending program 54 executes the steps of FIG. 7. And please also refer to FIGS. 10˜12 with FIG. 7 together.

Step 701:

Referring to FIG. 10, choose the target unknown-word 412 to change. For example, the word “fundamental” which has actually been learned by the user so that “fundamental” should be changed to a known-word 411. The way of choosing the target unknown-word 412 could be. For example: pressing the right button of a mouse (not shown here) and a window 701a will pop-up. Please notice that the unknown-word 412 (e.g. “fundamental”) could also be chosen from the unknown-vocabulary area 45.

Step 702:

Changing an unknown-word 412 to a known-word 411. In the embodiment of FIG. 10, the user chooses “Yes” from the window 701a.

Step 703:

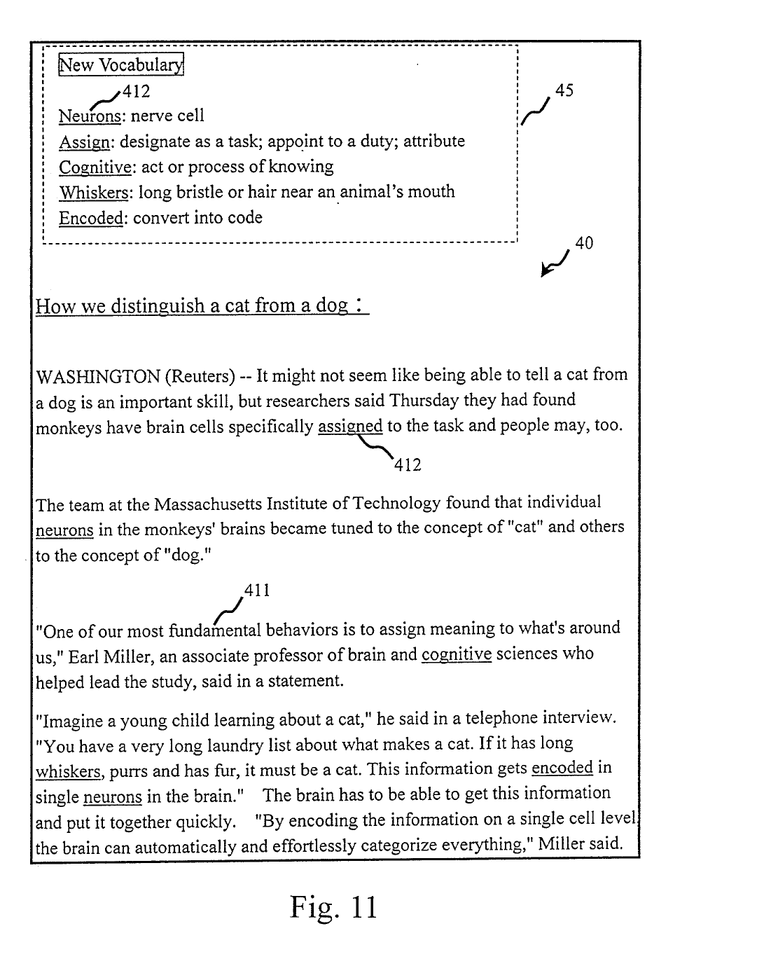

Removing the original marking (e.g. underline) of the unknown-word 412. Referring to FIG. 11, there is no underline under “fundamental” after it has been changed to a known word 411.

Step 704:

Updating the unknown-vocabulary area 45. Referring to FIG. 11, the word “fundamental” is not present in the unknown-vocabulary area 45 after being recognized as a known word 411 by the software program.

Step 705:

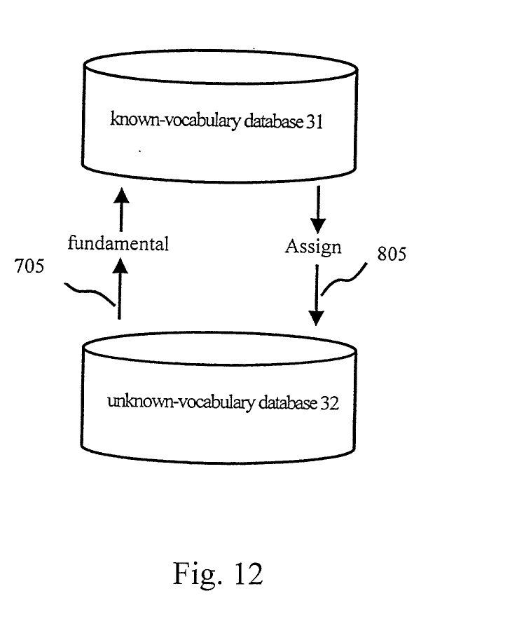

Removing the unknown-word 412 (e.g. “fundamental”) from the unknown-vocabulary database 32 and/or adding it to the known-vocabulary database 31. Referring to FIG. 12, in the embodiment, the unknown word 412, “fundamental”, is processed by the software program

Refer to FIG. 8 for the flowchart of changing a known word 411 to an unknown word 412. Amending program 54 also executes the steps of FIG. 8. And also refer to FIGS. 10˜12 with FIG. 7 together.

Step 801:

Referring to FIG. 10, choose the target known-word 411. For example, the word “assigned” which the user does not know such that “assigned” should be changed to an unknown word 412. The method of choosing the target known word 411 could be. For example: pressing the right button of a mouse (not shown here) and a window 801a will pop-up.

Step 802:

Changing a known-word 411 to an unknown-word 412. In the embodiment of FIG. 10, the user chooses “Yes” from the window 801a.

Step 803:

Adding a marking (e.g. underline in this embodiment) on the unknown word 412. Referring to FIG. 11, the word “assigned” has been underlined.

Step 804:

Referring to FIG. 11, the word “assigned” has been added in the unknown-vocabulary area 45.

Step 805:

Remove the known-word 411 (e.g. “assigned”) from the known-vocabulary database 31 and/or add it to the unknown-vocabulary database 32.

Notice that the flow charts FIGS. 5˜8 and FIG. 12 can also apply the combined database described in the FIG. 4. All the words with “NO” in the unknown flag column 343 can be referred to as known-vocabulary database 31. On the other hand, all the words with “YES” in the unknown flag column 343 can be referred to as unknown-vocabulary database 32. By changing the flag (e.g. “YES” or “NO”) in the unknown flag column 343, a known-word 411 can be changed to an unknown-word 412 and vice versa (see Step 705, 805). Therefore, either in the specification or in the claims, the known-vocabulary database 31 or the unknown-vocabulary database 32 may be an independent database or a database of the combined databases described in the FIG. 4 or the like.

Although the present invention has been described with reference to the preferred embodiments, it will be understood that the invention is not limited to the details described thereof. Various substitutions and modifications have been suggested in the foregoing description, and those with ordinary skill in the art will suggest others. Therefore, all such substitutions and modifications within the scope of the invention are to be embraced as defined in the appended claims. For example, to find an unknown word in a digital article 40 either exclusively use the known-vocabulary database 31 or exclusively use the unknown-vocabulary database 32. Therefore, although two databases 31, 32 or a combined database (e.g. database 31 and database 32) are preferred in the above embodiments, only one database (e.g. either database 31 or database 32) is needed to achieve the same purpose. Please also note that both database 31 and database 32 can be saved in the electronic apparatus 10, but can also be uploaded remotely such as from a server or website. In addition, if the digital article 40 is large, there can be multiple unknown-vocabulary areas 45. For example: each page shows an unknown-vocabulary area 45 for the text shown on each page or every three paragraphs. An article can be treated as many articles for assigning multiple unknown-vocabulary areas 45.

What is claimed is:

1. A method of displaying unknown words of a digital article comprising:
a) comparing the digital article with a vocabulary database to find unknown words in the digital article, wherein the vocabulary database is chosen from a known-vocabulary database, an unknown-vocabulary database, or a combined vocabulary database with a known-vocabulary database and an unknown-vocabulary database; and
b) marking found unknown word(s) so that a reader knows where unknown words(s) are in the digital article.

2. The method according to claim 1 wherein the step of marking found unknown word(s) is to add an underline under found unknown word(s).

3. The method according to claim 1 further comprising an amending step to change a known word to an unknown word of the digital article and vice versa, wherein the amending step will further update the vocabulary database.

4. The method according to claim 1 further comprising a combining step to display found unknown word(s) together as an unknown-vocabulary area.

5. The method of displaying unknown words of a digital article comprising:
a) comparing the digital article with a vocabulary database to find unknown word(s) in the digital article, wherein the vocabulary database is chosen from a known-vocabulary database, an unknown-vocabulary database, or a combined vocabulary database with a known-vocabulary database and an unknown-vocabulary database; and
b) displaying found unknown word(s) together as an unknown-vocabulary area.

6. The method according to claim 5 further comprising a marking step to mark found unknown word(s) so that a reader can know where unknown word(s) are in the digital article.

7. The method according to claim 5 further comprising an amending step to change a known word to an unknown word of the digital article and vice versa, wherein the amending step will further update the vocabulary database.

8. An article of manufacture comprising a computer-readable medium bearing a program code embodied therein for use in an electronic apparatus which is able to display digital articles, the article of manufacture comprising:
a first computer-readable program segment encoded on the computer-readable medium for comparing the digital article with a vocabulary database to find unknown word(s) in the digital article, wherein the vocabulary database is chosen from a known-vocabulary database, an unknown-vocabulary database, or a combined vocabulary database with a known-vocabulary database and an unknown-vocabulary database; and
a second computer-readable program segment encoded on the computer-readable medium for marking found unknown word(s) so that a reader knows where unknown-word(s) are in the digital article.

9. The article of manufacture according to claim 8 further comprising a third computer-readable program segment encoded on the computer-readable medium for changing a known word to an unknown word of the digital article and vice versa, and also updating the vocabulary database.

10. The article of manufacture according to claim 8 further comprising a fourth computer-readable program segment encoded on the computer-readable medium for displaying found unknown word(s) together.

11. The article of manufacture comprising a computer-readable medium bearing a program code embodied therein for use in an electronic apparatus which is able to display digital articles, the article of manufacture comprising:
a first computer-readable program segment encoded on the computer-readable medium for comparing the digital article with a vocabulary database to find unknown word(s) in the digital article, wherein the vocabulary database is chosen from a known-vocabulary database, an unknown-vocabulary database, or a combined vocabulary database with a known-vocabulary database and an unknown-vocabulary database; and
a second computer-readable program segment encoded on the computer-readable medium for displaying found unknown-word(s) together.

12. The article of manufacture according to claim 11 further comprising a third computer-readable program segment encoded on the computer-readable medium for changing a known word to an unknown word of the digital article and vice versa, and also updating the vocabulary database.

13. The article of manufacture according to claim 11 further comprising a fourth computer-readable program segment encoded on the computer-readable medium for marking found unknown word(s) so that a reader knows where unknown word(s) are in the digital article.

14. An electronic apparatus able to display a digital article and find unknown-word(s) in the digital article, the electronic apparatus comprising:
a display device;
a storage device; and
a processor connected to the storage device;
the storage device storing:
a program for controlling the processor; and
a vocabulary database, wherein the vocabulary database is chosen from a known-vocabulary database, an unknown-vocabulary database, or a combined vocabulary database with a known-vocabulary database and an unknown-vocabulary database; and
the processor operative with the program to:
compare the digital article with a vocabulary database to find unknown word(s) of the digital article; and
mark found unknown word(s) so that a reader knows where unknown word(s) are in the digital article.

15. The electronic apparatus according to claim 14 in which the processor is further operative with the program to change a known word to an unknown word of the digital article and vice versa, and also update the vocabulary database.

16. The electronic apparatus according to claim 14 in which the processor is further operative with the program to display found unknown word(s) together on the displaying device.

17. An electronic apparatus able to display a digital article and find unknown word(s) in the digital article, the electronic apparatus comprising:
a displaying device;
a storage device;
a processor connected to the storage device;
the storage device storing
a program for controlling the processor, and
a vocabulary database, wherein the vocabulary database is chosen from a known-vocabulary database, an unknown-vocabulary database, or a combined vocabulary database with a known-vocabulary database and an unknown-vocabulary database; and
the processor operative with the program to
compare the digital article with a vocabulary database to find unknown word(s) in the digital article; and
display found unknown word(s) together on the displaying device.

18. The electronic apparatus according to claim 17 in which the processor is further operative with the program to change a known word to an unknown word of the digital article and vice versa, and also update the vocabulary database.

19. The electronic apparatus according to claim 17 in which the processor is further operative with the program to mark found unknown word(s) so that a reader knows where unknown word(s) are in the digital article.
